(19) United States
(12) Patent Application Publication
(10) Pub. No.: US 2018/0047098 A1
(43) Pub. Date: Feb. 15, 2018

(54) COMPUTER IMPLEMENTED METHOD AND COMPUTER SYSTEM FOR AUCTIONING OR TRADING BETS

(71) Applicant: BETSOLD LIMITED, Glasgow (GB)

(72) Inventors: Nicola YOUNG, Glasgow (GB); Kevin MCMONAGLE, Troon (GB)

(73) Assignee: BETSOLD LIMITED, Glasgow (GB)

(21) Appl. No.: 15/790,447

(22) Filed: Oct. 23, 2017

Related U.S. Application Data
(63) Continuation-in-part of application No. PCT/GB2017/050620, filed on Mar. 8, 2017.

(30) Foreign Application Priority Data
Mar. 11, 2016 (GB) 1604218.6

(51) Int. Cl. G06Q 30/08

(52) U.S. Cl. CPC G06Q 30/08; G06Q 30/0283

(57) ABSTRACT

A method and apparatus for auctioning bets receives data on a bet placed on the outcome of an event and data identifying a seller from a seller interface, the data on the bet including data on the stake placed and the odds; generates auction data using the received data, the auction data including an auction end time prior to the event; generates an auction interface to display the auction data to bidders to create an auction; receives bid data associated with the auction data and data identifying a bidder from the auction interface; terminates the auction at the auction end time and determines a bidder with a highest bid; and electronically transfers the value of the highest bid to the seller and one of: assigns the bet to the highest bidder, and if the bet wins, electronically transfers the value of the winnings from the seller to the bidder with the highest bid.

### FIELD OF THE INVENTION

The present invention relates to a computer implemented method and a computer system for auctioning or trading bets.

### BACKGROUND INFORMATION

It is popular to place a bet on the outcome of an event, such as a sporting event, entertainment event, political event, and even the weather. Bets are placed based on odds offered for an expected outcome of the event and a monetary value in the form of a stake is placed. A person placing a bet will either be given a paper slip if the bet is placed in person or an electronic record if the bet is placed electronically e.g. over the internet. The entities offering to accept such bets are usually termed bookmakers. The bookmakers set the odd that they are prepared to offer for an event occurring. If the event outcome is as bet upon, the bookmaker will pay the person placing the bet (the bet owner) the winnings calculated based on the stake and the odds.

A bet thus has a potential monetary value and will have a termination point, which is the point in time at which an event outcome occurs, either as bet or not. Some bets can be simple, such as 10/1 it will snow on Christmas day, or complex based on a compound event such as 20/1 England will win by 3 goals, or multiple events such as 20/1 England will win and Wayne Rooney will score the first goal. In any of these cases there is a point at which the outcome of the bet upon event is determinable. There is also a point in time where the event is in progress and either bets can still be placed or cannot, e.g. on Christmas day or after the start of the game in the examples given above.

A bet can be placed on an event a long time in advance of the event. In the period after the placing of the bet and before the event occurs, circumstances can cause the likelihood of the bet upon outcome for the event occurring to change e.g. due to injuries to players or a change in weather conditions. The event occurrence can become more likely and hence, in this case, the odds offered by bookmakers for new bets are reduced.

### SUMMARY OF THE INVENTION

One aspect provides a computer implemented method of auctioning bets, the method comprising receiving data on a bet owned on the outcome of an event and data identifying a seller from a seller interface, the data on the bet including data on the stake and the odds; generating auction data using the received data, the auction data including an auction end time prior to the outcome of the event; generating an auction interface to display the auction data to bidders to create an auction; receiving bid data associated with the auction data and data identifying a bidder from the auction interface; terminating the auction at the auction end time and determining a bidder with a highest bid; and electronically transferring the value of the highest bid to the seller and one of: assigning the bet to the highest bidder, and if the bet wins, electronically transferring the value of the winnings from the seller to the bidder with the highest bid.

Another aspect of the invention provides a computer system for auctioning bets, the system comprising a program memory storing program code; and a processor for implementing the program code stored in the program memory; wherein the program code comprises code for controlling the processor to receive data on a bet owned on the outcome of an event and data identifying a seller from a seller interface, the data on the bet including data on the stake and the odds; code for controlling the processor to generate auction data using the received data, the auction data including an auction end time prior to an outcome of the event (which may or may not be the outcome bet upon i.e. the winning outcome); code for controlling the processor to generate an auction interface to display the auction data to bidders to create an auction; code for controlling the processor to receive bid data associated with the auction data and data identifying a bidder from the auction interface; code for controlling the processor to terminate the auction at the auction end time and determining a bidder with a highest bid; and code for controlling the processor to electronically transfer the value of the highest bid to the seller and one of: assign the bet to the highest bidder, and if the bet wins, electronically transfer the value of the winnings from the seller to the bidder with the highest bid.

Another aspect of the invention provides a computer implemented method for trading bets, the method comprising passing an electronic communication from a buyer to a seller requesting to buy a bet, the request identifying an outcome of an event and the desired price; receiving an electronic response from the seller confirming the availability of the bet for sale, the electronic response identifying a stake and odds offered for a price; electronically transmitting the electronic response identifying a stake and odds offered for an offered price to the buyer; receiving confirmation from the buyer with electronic payment for the bet at the offered price; passing the confirmation to the seller; one of: assigning the bet to the buyer, and if the bet wins, electronically transferring the value of the winnings from the seller to the buyer; and electronically transferring the value of the offered price to the seller.

Another aspect provides a computer system for trading bets, the system comprising a program memory storing program code; and a processor for implementing the program code stored in the program memory; wherein the program code comprises code for controlling the processor to pass an electronic communication from a buyer to a seller requesting to buy a bet, the request identifying an outcome of an event and the desired price; code for controlling the processor to receive an electronic response from the seller confirming the availability of the bet for sale, the electronic response identifying a stake and odds offered for a price; code for controlling the processor to electronically transmit the electronic response identifying a stake and odds offered for an offered price to the buyer; code for controlling the processor to receive confirmation from the buyer with electronic payment for the bet at the offered price; code for controlling the processor to pass the confirmation to the seller; code for controlling the processor to one of: assign the bet to the buyer, and if the bet wins, electronically transfer the value of the winnings from the seller to the buyer; and code for controlling the processor to electronically transfer the value of the offered price to the seller.

Another aspect provides a computer implemented method for the auctioning of bets, the method comprising receiving data on a bet owned on an outcome of an event and data identifying a seller from a seller interface, the data on the bet including data on a stake and the odds; generating and outputting auction data using the received data, the auction data including data identifying the event, the stake bet on the outcome of the event, a highest received bid, original odds for the outcome of the event at which the bet was placed, and odds currently being offered by third parties for the outcome of the event to enable a potential bidder to compare the original odds to the odds currently being offered by third parties; and receiving bid data for the bets from bidders, the bid data including the highest received offer.

Another aspect provides a computer system for the auctioning of bets, the system comprising a program memory storing program code; and a processor for implementing the program code stored in the program memory; wherein the program code comprises: code for controlling the processor to receive data on a bet owned on an outcome of an event and data identifying a seller from a seller interface, the data on the bet including data on a stake and the odds; code for controlling the processor to generate and output auction data using the received data, the auction data including data identifying the outcome of the event, the stake bet on the outcome of the event, a highest received bid, original odds for the outcome of the event at which the bet was placed, and odds currently being offered by third parties for the outcome of the event to enable a potential bidder to compare the original odds to the odds currently being offered by third parties; and code for controlling the processor to receive bid data for the bets from bidders, the bid data including the highest received offer.

Another aspect provides a computer implemented method of auctioning bets, the method comprising receiving data on a bet owned on the outcome of an outcome of an event and data identifying a seller from a bookmaker's computer, the data on the bet including data on the bet owner, the outcome of the event, the stake, the odds, and the bookmaker; generating auction data using the received data, the auction data including an auction end time prior to the outcome of the event; generating an auction interface to display the auction data to bidders to create an auction; receiving bid data associated with the auction data and data identifying a bidder from the auction interface; terminating the auction at the auction end time and determining a bidder with a highest bid; electronically transferring the value of the winnings from the seller to the bidder with the highest bid; electronically transferring the value of the highest bid to the seller; and transmitting data identifying the bet and bid data for the highest bidder to the bookmaker's computer for the transfer of the bet to the highest bidder.

Another aspect provides a computer system for auctioning bets, the system comprising a program memory storing program code; and a processor for implementing the program code stored in the program memory; wherein the program code comprises code for controlling the processor to receive data on a bet owned on an outcome of an event and data identifying a seller from a bookmaker's computer, the data on the bet including data on the bet owner, the outcome of the event, the stake, the odds, and the bookmaker; code for controlling the processor to generate auction data using the received data, the auction data including an auction end time prior to the outcome of the event; code for controlling the processor to generate an auction interface to display the auction data to bidders to create an auction; code for controlling the processor to receive bid data associated with the auction data and data identifying a bidder from the auction interface; code for controlling the processor to terminate the auction at the auction end time and determine a bidder with a highest bid; code for controlling the processor to electronically transfer the value of the winnings from the seller to the bidder with the highest bid; code for controlling the processor to electronically transfer the value of the highest bid to the seller; and code for controlling the processor to transmit data identifying the bet and bid data for the highest bidder to the bookmaker's computer for the transfer of the bet to the highest bidder.

### BRIEF DESCRIPTION OF THE DRAWINGS

FIG. 1 is a schematic diagram illustrating a computer system according to one embodiment;

FIG. 2 is a flow diagram illustrating the registration process according to one embodiment;

FIG. 3 is a flow diagram illustrating the process for listing a bet in an auction according to one embodiment;

FIG. 4 is a flow diagram illustrating the auction process of one embodiment;

FIG. 5 is an illustration of the user interface according to one embodiment;

FIG. 6 is a flow diagram illustrating the process for listing a bet in an auction according to another embodiment;

FIG. 7 is a flow diagram illustrating the auction process according to another embodiment;

FIG. 8 is a schematic diagram illustrating a computer system according to another embodiment;

FIG. 9 is a flow diagram illustrating the registration process according to a further embodiment;

FIG. 10 is a flow diagram illustrating the process of listing a bet in an auction using an auction computer according to a further embodiment;

FIG. 11 is a flow diagram illustrating the process of listing a bet in an auction using a bookmaker's computer according to a further embodiment;

FIG. 12 is a flow diagram illustrating the auction process according to a further embodiment; and

FIG. 13 is a flow diagram illustrating a process for selling bets according to another embodiment.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

In the following embodiments, like components are labelled with like reference numerals.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

A generalized embodiment provides for an electronic market for the exchange of ownership of bets. If a bet owner wishes to ‘cash out’ of their bet because, for example, they want the cash for another bet they prefer or because they no longer wish to maintain the bet on the event outcome, the computer system and method of embodiments enables the bet owner to offer to sell the bet in an auction environment. The starting price for the bet in the auction can be set at a minimum price by the owner (seller) which can be the price of the stake they placed, or it can be set at no minimum. The auction will have an auction end point which can be set by the seller or determined or set in dependence upon a signal from an external data source. The auction end can also be automatically determined based on data on the event, which can be provided from public data or from an external data source to ensure that the auction cannot continue beyond a certain point prior to the event outcome. In some cases (e.g. horse racing) this means that the auction can continue during the event up to a point prior to the ultimate determination (outcome) of the event outcome e.g. in a race, a period prior to the end of the race or in a game, a period prior to the end of the game. Where the auction end is determined by an external data feed, the data feed can comprise data transmitted ‘live’ from the event. Such data can include data on the end of an entire event, such as a game or a race, or data on the occurrence of an event within the entire event, such as a goal, try or points being scored, the falling of a horse or runner in a race, the halting due to mechanical failure or crashing of a car in a race, etc. The data feed can in one embodiment act as a data trigger transmitted over a communications network from a data feed source computer and received at the auction computer system to signal the end of the auction.

In the embodiment described, a bet is a risk of a sum of money or valued item against someone else's on the basis of the outcome of an unpredictable event such as a race or game. Odds reflect an opinion of the chances of an event outcome. Hence, a bet can also be considered as an individual having an opinion of the likelihood of that successful outcome occurring and placing monetary value on the opinion offered by the chances reflected in the odds. In commercial betting, the odds are offered or set by bookmakers, which are entities offering to accept a bet based on the odds they offer.

One embodiment provides a system in which sellers and bidders are required to accept legal terms and conditions to use the auction system. This is important to ensure that the bidder pays when they win the auction and the seller transfers the bet to the bidder if possible prior to the outcome of the event or transfers the winnings at the outcome of the event to bidder if the bet wins. One embodiment does not require data from the bookmaker in order to trade or auction the bet. Reliance is placed on the legal obligations of the parties and if a party abuses the process, they can be barred from using the system in the future. In one embodiment, the bidder is protected by the payment of their bid into a holding account or escrow for payment to the seller only upon transfer of the bid prior to the outcome of the event or the winnings at the winning outcome of an event.

In another embodiment, the auction system works in cooperation with a bookmaker's system to validate the bet before the bet can be entered into an auction. In such an arrangement the bookmaker's system can include a seller account in which the bet is electronically recorded. The bookmaker's system can hence be linked to the auction system and modified to enable a seller to select to auction their bet. Data on the selected bet is then transmitted to the auction system for a creation of an auction item. Upon completion of the auction, the auction system can transfer data identifying the bet and the winning bidder to the bookmaker's system to enable the bookmaker's system to transfer ownership to an account of the bidder or to invite the winning bidder to open an account to access the winnings. Such a system provides a self-validating bet auction arrangement with secure and reliable transaction processing.

Specific embodiments will now be described with reference to the drawings.

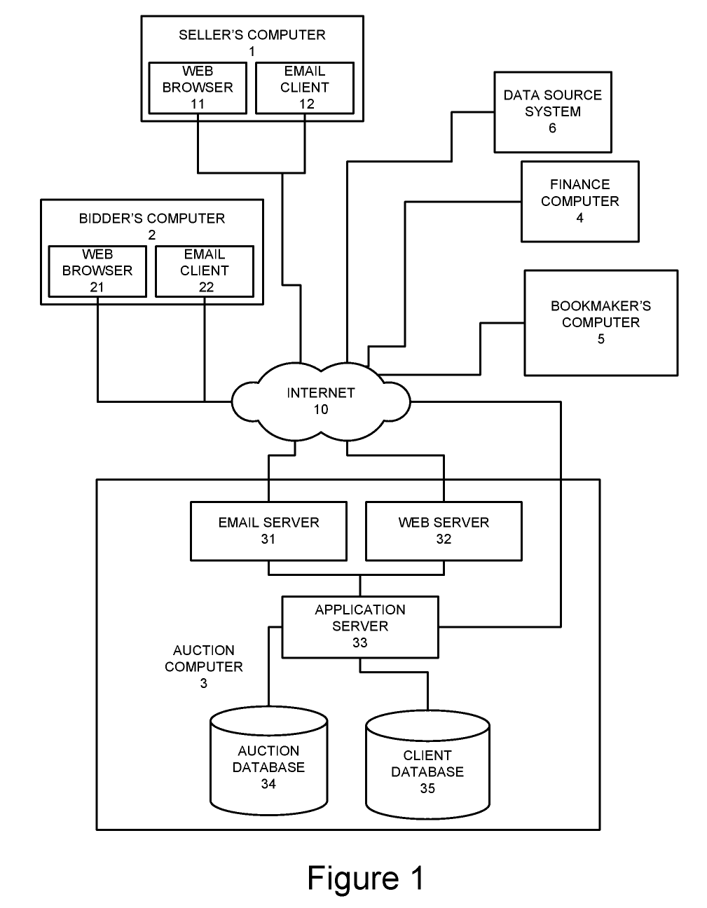

A first embodiment will be described with reference to FIGS. 1 to 4. FIG. 1 illustrates an auction system of one embodiment for implementing an electronic bet auction process.

An auction computer 3 is connected to a seller's computer 1 and a bidder's computer 2 over the internet 10. The internet 10 is a convenient network. However, any suitable communications network can be used such as a local area network, a wide area network, a mobile communications network, WiFi, Bluetooth etc. The auction computer 3 is also connected over the internet 10 to a finance computer 4 operated by a third party financial institution and to a bookmaker's computer 5 operated by a bookmaker who supplied the bet. Although only a single finance computer 4 and a single bookmaker's computer 5 is illustrated, multiple such computers can be provided operated by multiple finance institutions and bookmakers respectively.

A data source system 6 comprising one or more programmed computers is connected to the internet 10 to provide a source of event data for the auction computer 3. The data source system 6 can also provide a stream of live video data and other event data for specific events and the overall events which can be the subject of bets comprising auction lots. For example, the data source can provide video streams of sporting events and data on the event including event data. The data can be provided live so that the auction can be controlled in real time and be allowed to continue while the overall event is running until the occurrence of the event on which the bet is placed i.e. an interim event such as a goal, or the overall end of the event, such as the final whistle or the end of a race. Hence, the data feed provides a technical data source controlling the processing of auction data to change the state of the auction data to a final data state.

The event data represents data on an event that is external to the auction. In an embodiment, the event data represents data on the outcome on which the bet has been placed. The event can comprise the occurrence of the end of the event or something during an overall event. For example, the overall event can be a game, match, race etc. The event during the overall event can comprise a goal in a football match, a try in a rugby match, a touchdown in an American football game, a wicket in a cricket match, a horse falling at a fence in a horse race, etc. Hence, a user may have a bet on the overall outcome of the event or an interim event before the overall outcome of the event.

The seller's computer 1 implements a web browser 11 in software to access the functionality of the auction computer 3. Also, the seller's computer 1 implements an email client 12 to receive emails transmitted by the auction computer 3. Similarly, the bidder's computer 2 implements a web browser 21 in software to access the functionality of the auction computer 3 and an email client 22 to receive emails transmitted by the auction computer 3.

The auction computer 3 comprises a web server 32 for serving web pages for rendering by the web browsers 11 and 21 of the seller's computer 1 and the buyer's computer 2 respectively. The auction computer also implements an email server 31 for the generation of emails to the email clients 12 and 22 of the seller's computer 1 and the buyer's computer 2 respectively. The main functions of the auction computer 3 are performed by an application server 33, which accesses an auction database 34 and a client database 35. The functionality of the auction server can be provided alternatively by a suitable software and hardware combination including multiple hardware servers and alternative software such a Microsoft Service.

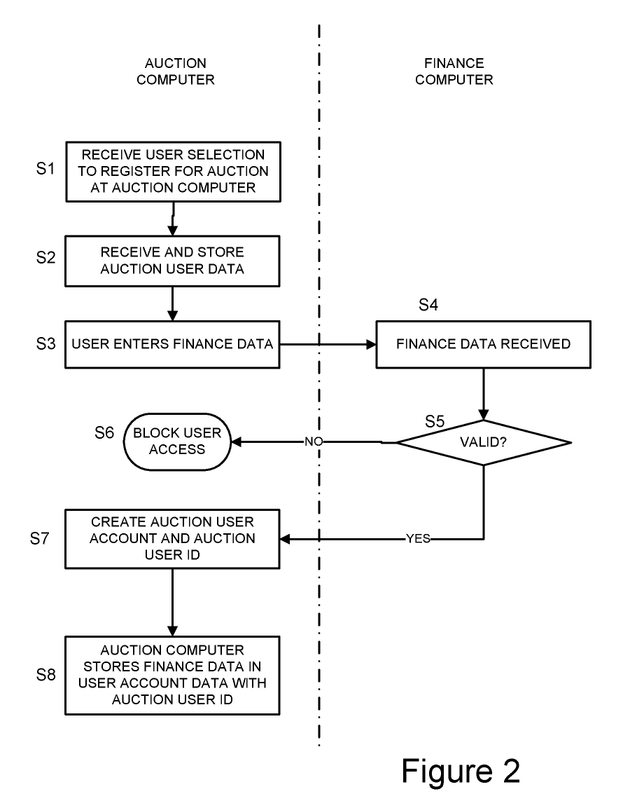

FIG. 2 illustrates a process for the registration of a user for use of the auction service, either as a seller or as a bidder. The registration process is performed by the cooperation of the auction computer 3 and the finance computer 4. It enables the identity and credit status of a user to be checked for the setting up of an account in the auction system.

In step S1 the auction computer 3 receives a user selection to register for the auction service via a web site hosted by the web server 32. The web server 32 provides a registration page on which the user can enter auction user data (step S2). The user also enters financial data in step S3 which enables the auction computer 3 to access a financial record in a finance computer 4 operated by a financial institution. The financial institution can comprise a payment service such as PayPal or WorldPay, a bank, or a credit card company. The financial data entered by the user is received by the finance computer 4 in step S4 to enable it to perform validation and credit checks (step S5). Such checks can comprise simply accessing a user's account using the access information passed to the finance computer 4. Alternatively, to avoid sensitive information being handled by the auction computer, in steps S3 and S4 a user is redirected to the finance computer 4 to log into their account for validation and credit checks in step S4. The finance computer 4 will transmit the result of the validation check to the auction computer 3. If the validation check fails, the auction computer 3 blocks access to the auction service in step S6. If the validation check is successful, the auction computer creates an auction user account with an auction user identifier (ID) in step S7. The finance data enabling the auction computer 3 to link with the finance computer 4 is then stored in the user account data with the auction user ID in step S8.

The auction user data stored in the client database 36 hence comprises the username, password, auction user ID, email address and finance data.

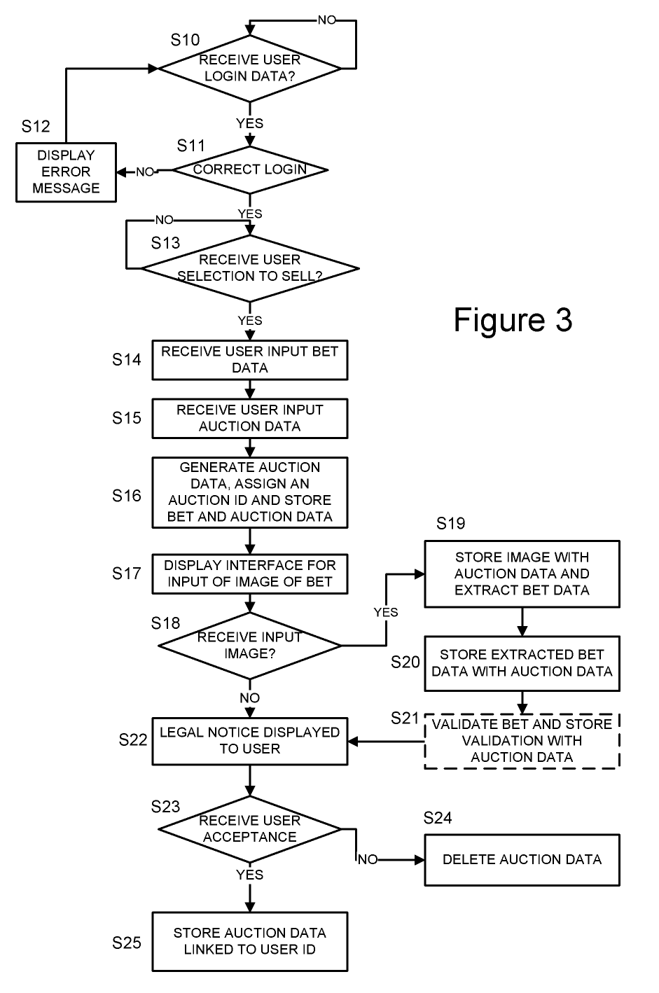

FIG. 3 is a flow diagram illustrating the process of listing a bet according to this embodiment.

In step S10 the web server 32 serves a login web page to the web browser 11 of the seller's computer 1 and waits for the seller to login with their username and password. If the login data is incorrect (step S11) an error message is generated as a web page or part and displayed on the web browser 11 of the seller's computer 1 (step S12) and the process returns to step S10. If the login data is correct (step S11) the web server 32 generates a web page allowing the seller to input a selection to sell a bet and the process waits for a user selection (step S13). When a user selection is made in step S13, the web page captures the seller's input bet data in step S14. The web page can provide predefined options for the entry of bet data to enable the seller to select from the options. These options are based on a database of future events and event outcomes that the system can have access to. For example, the seller can select a sport and the options will then be displayed to select an event e.g. horse racing and Cheltenham Gold Cup 12^{th} May 2014. The web page can then display the betting options including the event outcome in the form of a horse name, the type of bet e.g. win, place or each way, and the stake. The use of the options provides a simple form of validation of the bet i.e. there is an event an event outcome for the bet being entered into the auction. The seller can also be allowed to enter the data manually but the data may be flagged to indicate this. In step S15 a web page or part is generated to enable a user to input user auction data. Such data can comprise descriptive data, contact information, an end date and time for the auction as desired by the seller, and a starting price for the bet, which can be set at the price of the stake or at no minimum starting price for example. In step S16 auction data is generated for the auction item, an auction ID is assigned and the bet data and the auction data are stored. The bet data comprises a bet ID, data identifying the outcome of the event (event name, location, date and time, event outcome, value of bet (stake), the odds, the type of bet e.g. win, place or each way, bookmaker information (ID, name, branch, reference), and auction user ID (seller ID). The auction data is generated to comprise the auction ID, the bet ID, and an end date and time. The auction data will also include bid IDs when bids are received for the auction item. The auction end date and time can be automatically generated with reference to the event date and time or received event data to ensure that the auction end time is in advance of the occurrence of the auction event. Alternatively, the system can allow the seller to enter an auction end date and time as part of the user input of the user input auction data in step S15.

In step S17 the web server 3 generates a web page to enable the seller to upload an image of the bet. Where the seller has a physical betting slip, the required image can be a scan or digital photograph of the betting slip. Where the seller has placed the bet electronically e.g. on a bookmaker's web site, the required image can be a screen capture of the bet information. In this embodiment, the input of an image is not a requirement to list the bet in the auction. Seller are however encouraged to do so since their bet is visible to bidders and can be verified by the system with the bookmakers, thereby giving the bidders some comfort that the bet is genuine.

If the seller takes the option to upload an image of the bet in step S18, the image is received and stored with the auction data and bet data is extracted from the image of the bet using optical character recognition and a simple parsing process to identify the relevant data fields. The extracted bet data is stored with the auction data (step S20). This embodiment can also optionally undertake an automated or even a manual bet validation process (step S21). Under this process, the bet data extracted from the bet can as a first level of validation be compared with the data entered by the seller. If there is a discrepancy this can be indicated to the seller. The seller can accept the extracted data, by effectively acknowledging their input error, or decline to accept the extracted data as correct. The extracted bet data can further be compared with bet data held by the bookmaker that issued the bet. The bookmaker is identified in the bet data. The process can automatically communicate with the bookmaker's computer 5 over the internet 10 by looking up suitable communication details identified from the bookmaker's data in the bet data. Alternatively, the process can be performed manually e.g. over the telephone by an operator of the auction computer 3. If there is a discrepancy this can be indicated to the seller. The seller can accept the validated data, by effectively acknowledging their input error, or decline to accept the validated data as correct.

At the end of the validation process of step S21 or if the seller selects not to input an image of the bet in step S18, the web server 32 generates a legal notice for display by the web browser 11 on the seller's computer 1. This notice sets out the terms and conditions that the seller must accept to use the auction service. If the user selects not to accept the terms and conditions (step S23), the auction data is deleted in step S24 and the auction listing process stops. If the user selects to accept the terms and conditions (step S23), the auction data is stored linked to the user ID. The bet listing process is thus complete.

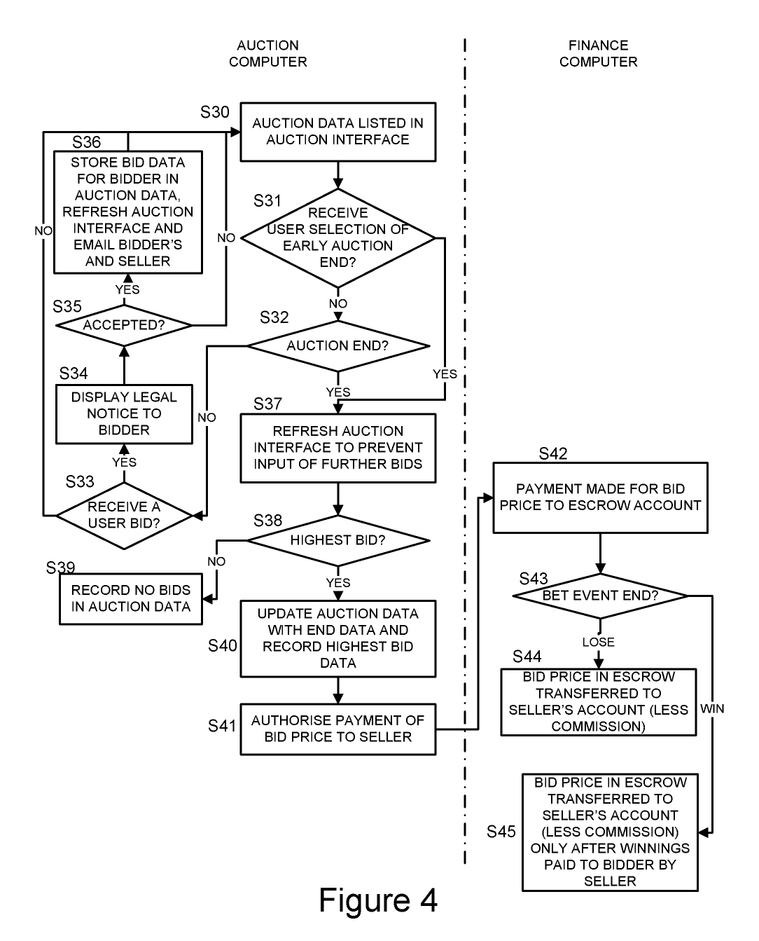

FIG. 4 is a flow diagram illustrating the process for the auctioning of a bet in accordance with one embodiment.

In step S30 the web server 32 generates a web page as an auction interface listing one or more auction items comprising bets listed by sellers. The process will be described with reference to the display of only one auction item. The item is listed in an auction until the end of the auction. The listing of each bet as an auction item comprises displaying the bet information. On an initial display of a list of auction items limited bet data could be displayed. When a user selects the auction item (bet) the full set of bet data is displayed, which includes an indication of whether or not the bet has been validated and if so a link to view any validation data such as an image of the betting slip or electronic bet record. In step S31 at any point in the auction in this embodiment a seller can make a selection using the interface to end the auction early. This could be to withdraw the bet from the auction or to accept the current highest bid. If the user has not selected to end the auction early in step S31. The process determines whether the date and time match the date and time set in the auction data for the end of the auction or if auction data has been received from the data source system 6 indicating the auction should be ended due to the occurrence of an event the subject of the bet (step S32). If not, the auction process waits to receive bids in step S33 and if none are received it returns in a loop back to step S30. If a bid is input by a bidder (step S33), the web server 32 generates a legal notice as a web page or part for display by the web browser 22 of the bidder's computer 2 (step S34). If the user does not select to accept the terms and conditions of the legal notice (step S35), the process loops back to step S30. If the user selects to accepts the terms and conditions in step S36 bid data is stored for the bidder in the auction data and the auction interface is refreshed to show the current bid state for the auction item. Also, the seller and all bidders for the bet are sent emails by the email server 31. The bid data comprises the auction ID, the bid value, date and time, and the auction user ID. The process then loops back to step S30 to repeat until the auction ends at step S31 or step S32.

At the end of the auction (step S37) the auction interface provided by the web server 32 is refreshed to show the end status of the auction to bidders and the seller to prevent further bids. The process then determines if there is a highest bid i.e. any bid above the reserved minimum price set by the seller (step S38). If not a record of no bids is stored in the auction data (step S39) and the process for the auctioning of the bet is finished.

If there is a bid above the minimum set by the seller (step S38), the auction data is updated with end of auction data including a record of the highest bid and the auction end date and time (step S40). The auction record can include a record of all bids for the auction item (bet). Payment of the bid price to the seller by the finance computer 4 is then authorized in step S41 by the auction computer 3. In step S42 the payment computer makes an electronic payment of the highest bid price from the account of the highest bidder into a holding or escrow account. The money will stay in this account until the bet event outcome (step S43). If the bet loses, the highest bid price paid by the highest bidder held in the holding or escrow account is transferred to the seller's account less commission charges by the auction operator and possibly by the financial institution (step S44). If the bet wins, the highest bid price paid by the highest bidder held in escrow is transferred to the seller's account less commission charges by the auction operator and possibly by the financial institution only after the winnings are paid by the seller to the highest bidder (step S45). This provides the bidder with some comfort that if the seller does not pay the winnings at least they can get their bid back from the escrow account.

The auction processes described with reference to FIGS. 3 and 4 enable an auction entity to operate an auction computer without interfacing to bookmaker's computers. The auctioning of bets can be provided by verifying the identity and credit status of users with the assistance of a financial institution.

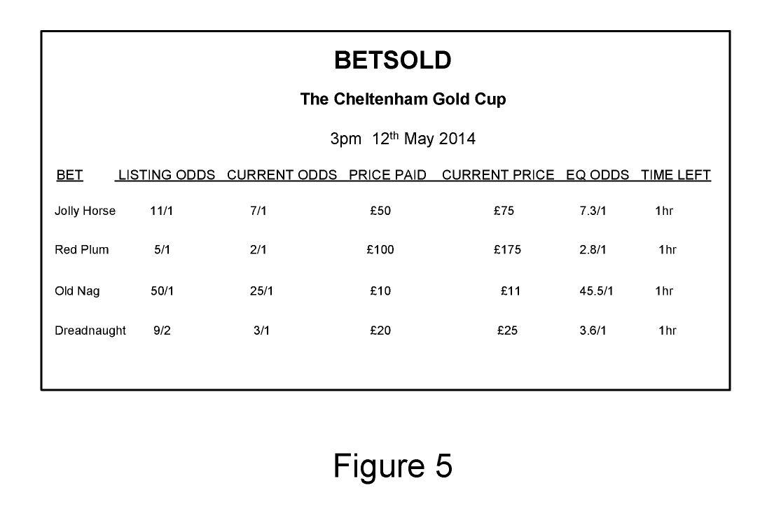

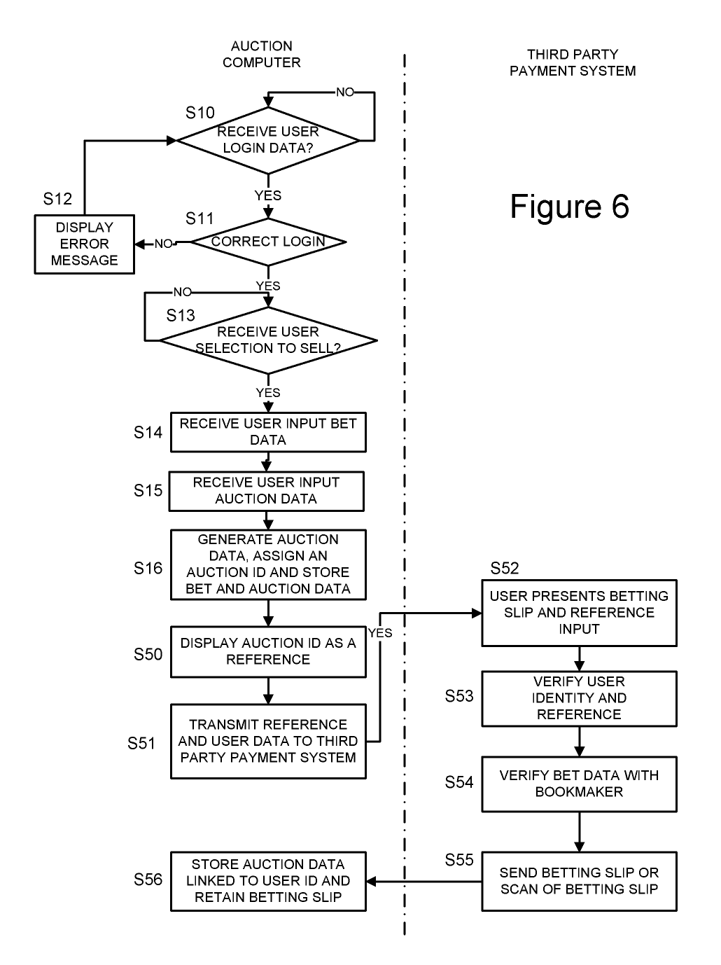

FIG. 5 illustrates an auction interface generated by an auction computer according to one embodiment of the invention. The auction process can comprise the auction process described with reference to FIGS. 1 to 4 or with reference to any of FIGS. 6 to 12 herein after. The interface can be generated by a server and transmitted to a bidder's computer acting as a client computer. In one embodiment, the interface can be provided as a web page or part by a web server such as the web server 32 of FIG. 1 for display on a web browser such as the web browser 21 of FIG. 1.

As can be seen in FIG. 5, bets are displayed for the outcome of an event, which in this example is a horse race. The name of the event and the date and time are displayed. For each bet, the bet data is displayed which comprises the event focus i.e. the horse name, the listing odds which comprise the odds at the time the bet was placed, the current odds offered externally, the price paid i.e. the stake, the current bid price, the equivalent odds, and the time left until the end of the auction for the bet. The display of the original odds at which the bet was placed and the current odds enables a potential bidder to easily determine if the odds have improved and whether it is worth bidding for the bet. To further inform the potential bidder, the application server 33 calculates the equivalent odds for the current bid price. The equivalent odds are calculated by determining the bet value if won, which for Jolly Horse is 11/1* £50=£550 and then dividing by the current price £75. This gives an equivalent odd of 7.3/1. This indicates the current odds that would be required to achieve the same winning price. It can be see that the current odds offered by the bookmakers are 7/1. Hence, the current bid price for the bet is only able to achieve a potential win value slightly higher than can be achieved by placing a bet with the bookmakers at the current odds. However, if the auction data for Old Nag are considered, it can be seen that the equivalent odds are 45.5/1 as compared with the current odds offered by the bookmakers of 25/1. Hence, purely considering the odds, this might be an attractive bet to bid for with a potential high comparative return.

The current odds displayed in FIG. 5 are offered by external entities in two forms, namely as fixed odds (an ante post bet) in advance of the event and todays (live) odds, which are offered on the day of the event or during the event for some type of events. The external entities can comprise a single bookmaker or bookmaker company, a group of bookmakers, or some other odds providing entity. Such an odds providing entity can take the odds from bookmakers and generate a compilation, such as an average of the odds offered externally. For a fixed odds bet the risk to the bidder can be higher due to events, which can occur prior to the event to change the outcome of the event. For example, in horse racing a bidder may have place a bet on a horse that is withdrawn from the race. The odds available to the bidder change from the fixed odds to the live odds at a predetermined period before the event or at the start of the event. In the prior art bookmakers and other odds setting entities keep the data for the two types of odd separate. The current odds used in this embodiment are a combination based on the two types of external odds. The system takes two separate data feeds from the bookmakers, or odds providing entity; one for the fixed odds and one for the live odds. The current odds displayed are the odds available to a potential bidder in the external market at the time they view the display. Hence, the feeds from the odds provider need to be real time or near real time to avoid the current odds being out of date.

The bid data creates internal market prices and based on the bookmakers odds feed, displaying (external) market prices in comparison to internal market prices (where the perceived internal market price is directly influenced by the external market)

In order to place a bid for a bet (auction item) a bidder can select the horse by for example clicking on it using a pointer, hand-held device or touching the screen of a touch screen. A bid entry interface will then be displayed to the bidder by the auction computer 3 e.g. as a web page served by the web server 32, to enable the entry of bid data.

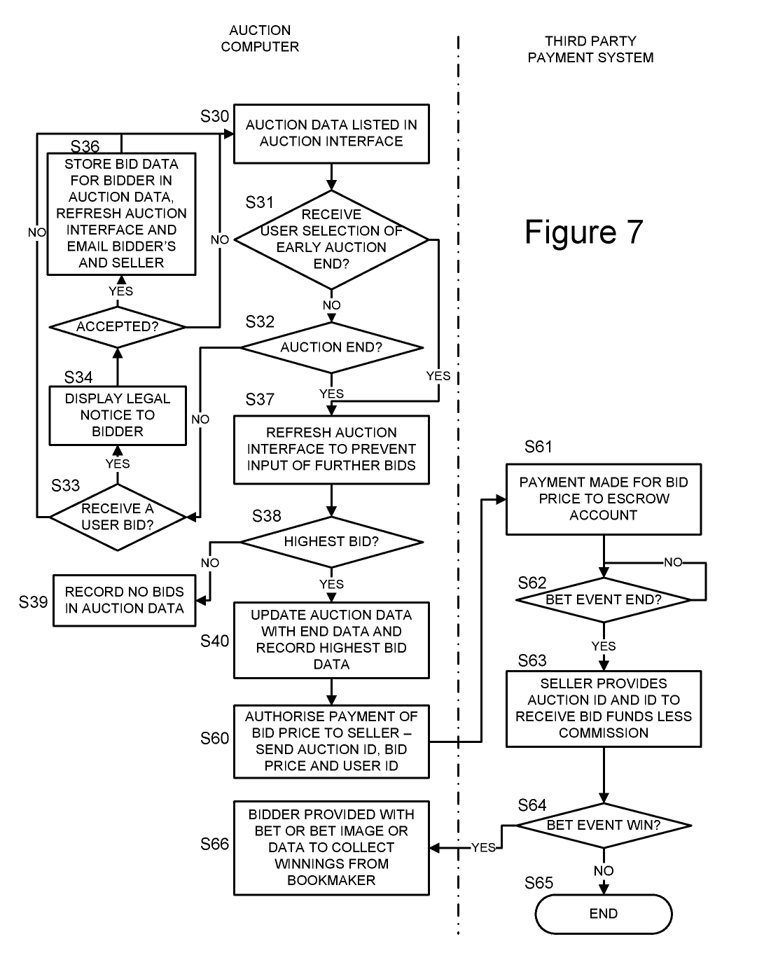

FIGS. 6 and 7 illustrate an auction process according to another embodiment in which a seller is able to use a third party payment system to obtain the highest bid payment as cash.

FIG. 6 is a flow diagram illustrating the process of listing a bet according to another embodiment involving a third party payment system. Steps S10 to S16 are similar to the embodiment of FIG. 3 and the system is similar to that shown in FIG. 1 with the addition of a third party payment system which may or may not be connected to the internet 10.

In step S10 the web server 32 serves a login web page to the web browser 11 of the seller's computer 1 and waits for the seller to login with their username and password. If the login data is incorrect (step S11) an error message is generated as a web page or part and displayed on the web browser 11 of the seller's computer 1 (step S12) and the process returns to step S10. If the login data is correct (step S11) the web server 32 generates a web page allowing the seller to input a selection to sell a bet and the process waits for a user selection (step S13). When a user selection is made in step S13, the web page captures the seller's input bet data in step S14. The web page can provide predefined options for the entry of bet data to enable the seller to select from the options. These options are based on a database of future events and event outcomes that the system can have access to. For example, the seller can select a sport and the options will then be displayed to select an event e.g. horse racing and Cheltenham Gold Cup 12^{th} May 2014. The web page can then display the betting options including the event outcome in the form of a horse name, the type of bet e.g. win, place or each way, and the stake. The use of the options provides a simple form of validation of the bet i.e. there is an event an event outcome for the bet being entered into the auction. The seller can also be allowed to enter the data manually but the data may be flagged to indicate this. In step S15 a web page or part is generated to enable a user to input user auction data. Such data can comprise descriptive data, contact information, an end date and time for the auction as desired by the seller, and a starting price for the bet, which can be the price of the stake or no minimum starting price for example. In step S16 auction data is generated for the auction item, an auction ID is assigned and the bet data and the auction data are stored. The bet data comprises a bet ID, data identifying the outcome of the event (event name, location, date and time, event outcome, value of bet (stake), the odds, the type of bet e.g. win, place or each way, bookmaker information (ID, name, branch, reference), and auction user ID (seller ID). The auction data is generated to comprise the auction ID, the bet ID, and an end date and time. The auction data will also include bid IDs when bids are received for the auction item. The auction end date and time can be automatically generated with reference to the event date and time or received event data to ensure that the auction end time is in advance of the occurrence of the auction event. Alternatively, the system can allow the seller to enter an auction end date and time as part of the user input of the user input auction data in step S15.

In step S50 the web server displays the auction ID to the seller. This enables the seller to take this reference to an establishment of a third party payment entity with a betting slip as will be described below. The auction computer 3 transmits the auction reference and user data to a third party payment system. This can either be electronically or manually, such as by facsimile.

A seller wishing to access cash for their bet can present their betting slip with the auction reference given to them in step S50 to an office or outlet of the third party payment entity, whereupon an operator inputs the data (step S52). The seller will be required to provide evidence of their identity which will be checked along with the betting slip data by the third party payment entity to verify the user identify and the reference. The third party payment entity can undertake to verify the bet data with the bookmaker identified in the bet data. This can be performed manually e.g. by calling the bookmaker, or by electronically communicating with the bookmaker's computer 5 such as over the internet 10. The result of the verification process i.e. verified or not, can be added to the bet data. The betting slip or a scan of the betting slip can then be transmitted to the auction computer (step S55) along with the results of the verification process. In step S56 the auction data is stored linked to the user ID and the betting slip is retained or the image is stored in the auction data or bet data along with the result of the verification process. The bet listing process is thus complete.

FIG. 7 is a flow diagram illustrating the process for the auctioning of a bet in accordance with another embodiment.

In step S30 the web server 32 generates a web page as an auction interface listing one or more auction items comprising bets listed by sellers. The process will be described with reference to the display of only one auction item. The item is listed in an auction until the end of the auction. In step S31 at any point in the auction in this embodiment a seller can make a selection using the interface to end the auction early. This could be to withdraw the bet from the auction or to accept the current highest bid. If the user has not selected to end the auction early in step S31. The process determines whether the date and time match the date and time set in the auction data for the end of the auction or if auction data has been received from the data source system 6 indicating the auction should be ended due to the occurrence of an event the subject of the bet (step S32). If not, the auction process waits to receive bids in step S33 and if none is received it returns in a loop back to step S30. If a bid is input by a bidder (step S33), the web server 32 generates a legal notice as a web page or part for display by the web browser 22 of the bidder's computer 2 (step S34). If the user does not select to accept the terms and conditions of the legal notice (step S35), the process loops back to step S30. If the user selects to accept the terms and conditions in step S36 bid data is stored for the bidder in the auction data and the auction interface is refreshed to show the current bid state for the auction item. In addition, the seller and all bidders for the bet are sent emails by the email server 31. The bid data comprises the auction ID, the bid value, date and time, and the auction user ID. The process then loops back to step S30 to repeat until the auction ends at step S31 or step S32.

At the end of the auction (step S37), the auction interface provided by the web server 32 is refreshed to show the end status of the auction to bidders and the seller to prevent further bids. The process then determines if there is a highest bid i.e. any bid above the reserved minimum price set by the seller (step S38). If not a record of no bids is stored in the auction data (step S39) and the process for the auctioning of the bet is finished.

If there is a bid above the minimum set by the seller (step S38), the auction data is updated with end of auction data including a record of the highest bid and the auction end date and time (step S40). The auction record can include a record of all bids for the auction item (bet). Payment of the bid price to the seller by the finance computer 4 is then authorized in step S60 by the auction computer 3 and the auction computer 3 send the auction ID, the highest bid price and the auction user ID to the third party payment computer. In step S61, the third party payment computer makes an electronic payment of the highest bid price from the account of the highest bidder into an escrow account. The money will stay in this account until the bet event outcome (step S62), whereupon the seller can visit a premises of the third party payment entity and provide the auction ID and ID to confirm their identity to receive the highest bid funds less commission charges by the auction service provider and the third party payment entity (step S63).

If the bet does not win (step S64), the process stops at step S65. If the bet wins, the auction computer 3 provides the highest bidder with the physical betting slip or an image of the bet and/or bet data (step S66) to enable the highest bidder to collect the winnings from the bookmaker with whom the seller made the bet.

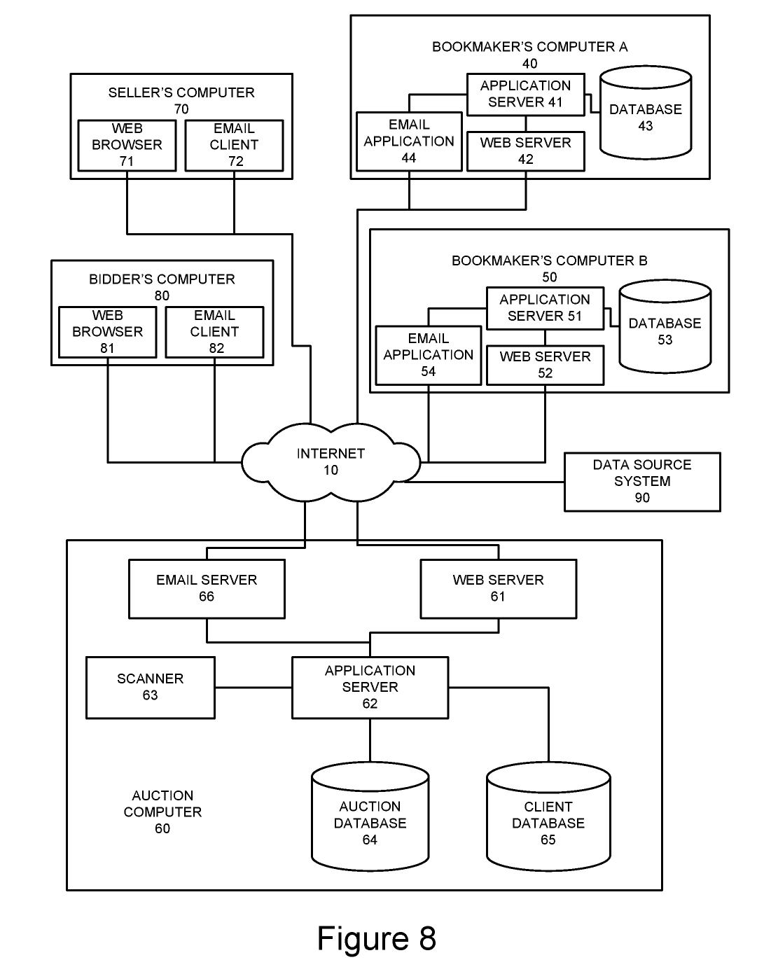

Another embodiment will now be described with reference to FIGS. 8 to 12, which includes two alternative methods of listing a bet for auction, namely using the auction computer or using the bookmaker's computer.

FIG. 8 illustrates an auction system of this embodiment for implementing an electronic bet auction process.

An auction computer 60 is connected to a seller's computer 70 and a bidder's computer 80 over the internet 10. The internet 10 is a convenient network. However, any suitable communications network can be used such as a local area network, a wide area network, a mobile communications network, Wi-Fi, Bluetooth etc. The auction computer 60 is also connected over the internet 10 to two similar bookmaker's computer 40 and 50, each operated by a bookmaker who supplies a bet. Although only two bookmaker's computers 40 and 50 are illustrated, any plurality of such computers can be provided operated by a plurality of bookmakers respectively.

A data source system 90 implemented as one or more programmed computers is connected to the internet 10 to provide a source of event data for the auction computer 60. The data source system 90 can also provide a stream of live video data and other event data for specific events and the overall events which can be the subject of bets comprising auction lots. For example, the data source can provide video streams of sporting events and data on the event including event data.

The event data represents data on an event that is external to the auction. In an embodiment, the event data represents data on the outcome on which the bet has been placed. The event can comprise the occurrence of the end of the event or something during an overall event. For example, the overall event can be a game, match, race etc. The event during the overall event can comprise a goal in a football match, a try in a rugby match, a touchdown in an American football game, a wicket in a cricket match, a horse falling at a fence in a horse race, etc. Hence, a user may have a bet on the overall outcome of the event or an interim event before the overall outcome of the event.

The seller's computer 70 implements a web browser 71 in software to access the functionality of the auction computer 60. In addition, the seller's computer 70 implements an email client 72 to receive emails transmitted by the auction computer 60. Similarly, the bidder's computer 80 implements a web browser 81 in software to access the functionality of the auction computer 80 and an email client 82 to receive emails transmitted by the auction computer 60.

The auction computer 60 comprises a web server 62 for serving web pages for rendering by the web browsers 71 and 81 of the seller's computer 70 and the buyer's computer 80 respectively. The auction computer 60 also implements an email server 66 for the generation of emails to the email clients 72 and 82 of the seller's computer 70 and the buyer's computer 80 respectively. The main functions of the auction computer 60 are performed by an application server 62, which accesses an auction database 64 and a client database 65. The functionality of the auction server 62 can be provided alternatively by a suitable software and hardware combination including multiple hardware servers and alternative software such a Microsoft Service. The auction server 60 also includes a scanner 63 for the scanning of betting slips.

The bookmaker's computers 40 and 50 each comprise a web server 42 and 52, an application server 41 and 51, an email application 44 and 54 and a database 43 and 53.

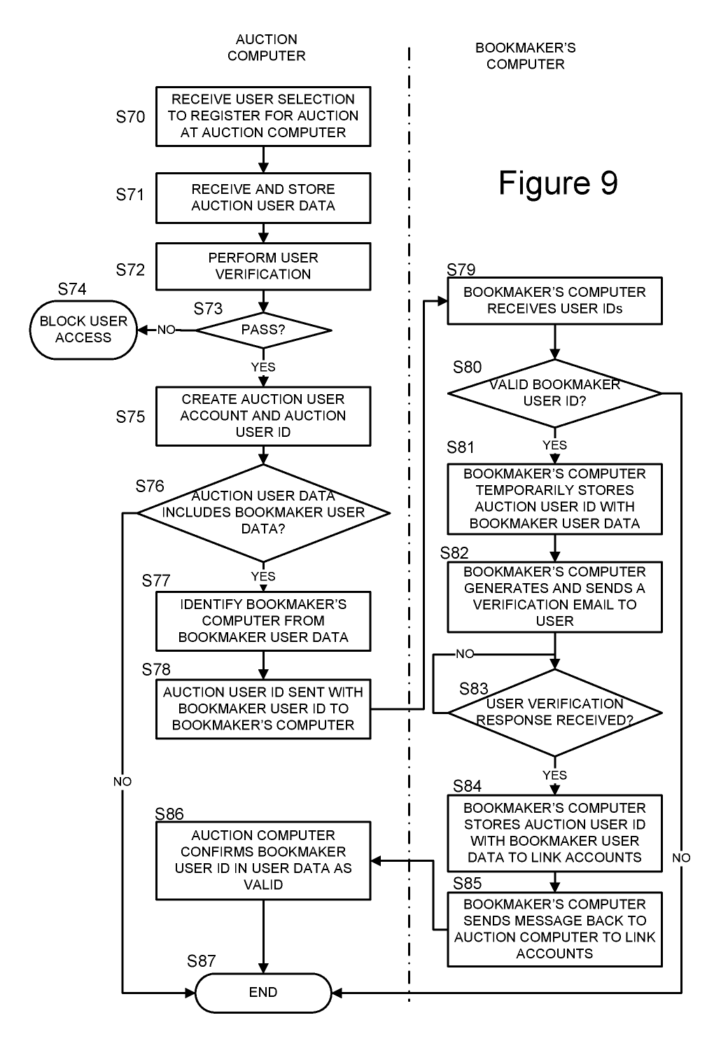

FIG. 9 illustrates a process for the registration of a user for use of the auction service, either as a seller or as a bidder. The registration process is performed by the cooperation of the auction computer 60 and a bookmaker's computer 40 or 50. It enables the identity and credit status of a user to be checked for the setting up of an account in the auction system by reference to an account at the bookmaker's computer and it links the accounts at the bookmaker's computer 40 or 50 and the auction computer 60.

In step S70, the auction computer 60 receives a user selection to register for the auction service via a web site hosted by the web server 61. The web server 61 provides a registration page on which the user can enter auction user data (step S71). The web page can provide predefined options for the entry of bet data to enable the seller to select from the options. These options are based on a database of future events and event outcomes that the system can have access to. For example, the seller can select a sport and the options will then be displayed to select an event e.g. horse racing and Cheltenham Gold Cup 12^{th} May 2014. The web page can then display the betting options including the event outcome in the form of a horse name, the type of bet e.g. win, place or each way, and the stake. The use of the options provides a simple form of validation of the bet i.e. there is an event an event outcome for the bet being entered into the auction. The seller can also be allowed to enter the data manually but the data may be flagged to indicate this. The process then performs user verification in step S72. One such verification can be by the entry of financial data, which enables the auction computer 60 to access a financial record in a finance computer operated by a financial institution. The financial institution can comprise a payment service such as PayPal or WorldPay, a bank, or a credit card company. The financial data entered by the user enable financial institution to perform validation and credit checks. If the validation check fails, the auction computer 60 blocks access to the auction service in step S74. If the validation check is successful, the auction computer creates an auction user account with an auction user identifier (ID) in step S75.

The auction user data stored in the client database 36 comprises the username, password, auction user ID, email address and bookmaker data comprising a bookmaker ID and a bookmaker user ID, which requires validation by a bookmaker.

In step S76, it is determined whether the auction user data includes bookmaker data. If it does not the process ends in step S87. If it does, the bookmaker's computer 40 or 50 is identified using the bookmaker ID in the bookmaker data (step S77). The auction computer 60 then sends the auction user ID with the bookmaker user ID to the bookmaker's computer 40 or 50 (step S78). The bookmaker's computer 40 or 50 receives the auction user ID and the bookmaker user ID (step S79) and determines whether the bookmaker user ID is valid (step S80). If not, the process ends at step S87. If so, the bookmaker's computer 40 or 50 temporarily stored the auction user ID with the bookmaker user data (step S81). The bookmakers' computer then generates and sends a verification email to the user (step S83) and awaits an email response or a selection of a web link for user verification (step S83). The bookmaker's computer 40 or 50 then stores the auction user ID in the database 43 or 53 with the bookmaker user data to link the accounts (step S84). The bookmaker's computer 40 or 50 then sends a message back to the auction computer to link the accounts (step S85). The auction computer confirms the bookmaker user ID in the auction user data as valid (step S86) and the registration process is complete (step S87).

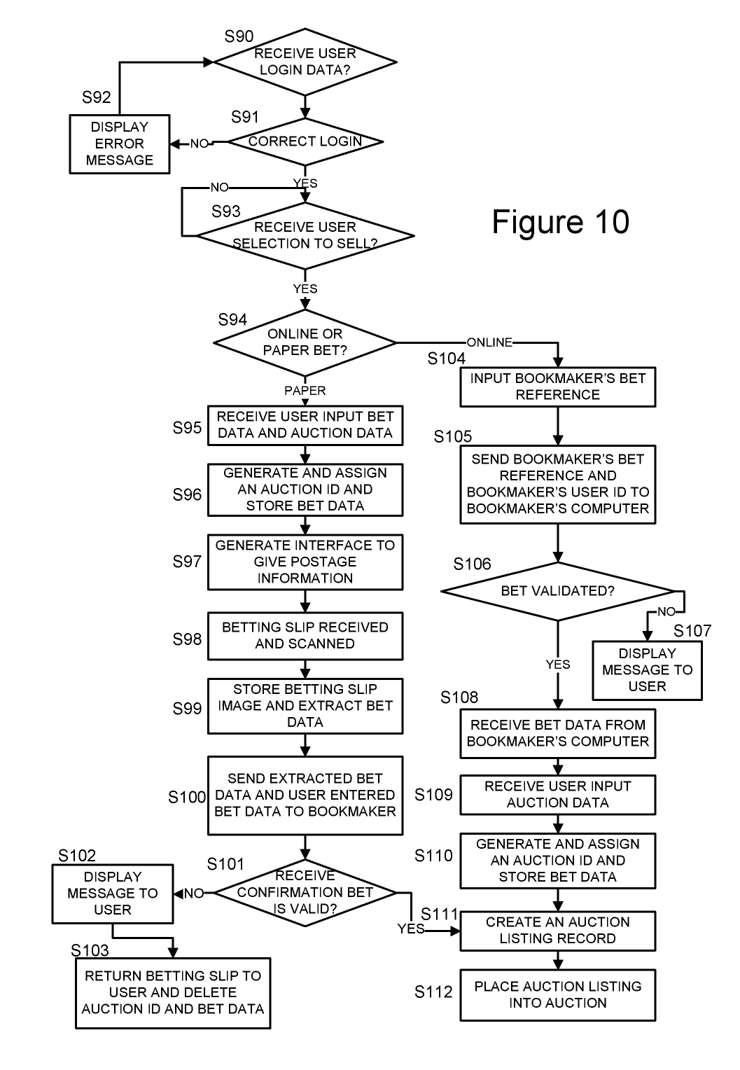

FIG. 10 is a flow diagram illustrating the process of listing a bet using the auction computer 60 according to this embodiment.

In step S90, the web server 61 serves a login web page to the web browser 71 of the seller's computer 70 and waits for the seller to login with their username and password. If the login data is incorrect (step S91) an error message is generated as a web page or part and displayed on the web browser 71 of the seller's computer 70 (step S92) and the process returns to step S90. If the login data is correct (step S91), the web server 61 generates a web page allowing the seller to input a selection to sell a bet and the process waits for a user selection (step S93). When a user selection is made in step S93, the user is asked to select whether the bet is an online bet or a paper bet (step S94). If the bet is a paper bet, the web page captures the seller's input bet data and user auction data in step S95. A web page can provide predefined options for the entry of bet data to enable the seller to select from the options. These options are based on a database of future events and event outcomes that the system can have access to. For example, the seller can select a sport and the options will then be displayed to select an event e.g. horse racing and Cheltenham Gold Cup 12^{th} May 2014. The web page can then display the betting options including the event outcome in the form of a horse name, the type of bet e.g. win, place or each way, and the stake. The use of the options provides a simple form of validation of the bet i.e. there is an event an event outcome for the bet being entered into the auction. The seller can also be allowed to enter the data manually but the data may be flagged to indicate this.

The user auction data can comprise descriptive data, contact information, an end date and time for the auction as desired by the seller, and a starting price for the bet, which can be set at the price of the stake or at no minimum starting price for example. In step S96 auction data is generated for the auction item (bet), an auction ID is assigned and the bet data and the auction data are stored. The bet data comprises a bet ID, data identifying the event (event name, location, date and time, event occurrence, value of bet (stake), the odds, bookmaker information (ID, name, branch, reference), and auction user ID (seller ID). The auction data is generated to comprise the auction ID, the bet ID, and an end date and time. The auction data will also include bid IDs when bids are received for the auction item. The auction end date and time can be automatically generated with reference to the event date and time to ensure that the auction end time is in advance of the occurrence of the auction event. Alternatively, the system can allow the seller to enter an auction end date and time as part of the user input of the user input auction data in step S95.

In step S97, the web server 61 generates an interface to display postage information to the user (seller) to enable the user to post the betting slip to the auction service provider operating the auction computer 60. In step S98, the betting slip is received and scanned using the scanner 63. In step S99, the betting slip image is stored with the auction data and bet data is extracted from the image of the betting slip using optical character recognition and a simple parsing process to identify the relevant data fields. The extracted bet data is sent with the user entered bet data to the bookmaker manually or electronically (step S100). If the bet is not confirmed valid by the bookmaker (step S101), a message is generated by the auction computer for display to the user (step S102) to inform the user. The betting slip is returned to the user and the bet data and auction ID are deleted (step S103).

If the bet is determined to be valid by the bookmaker (step S101), an auction listing record is created (step S111) and the auction listing is placed into an auction (step S112). The bet listing process is thus complete.

If in step S94 the user selects that the bet is an online bet, the user is requested to input the bookmaker's bet reference (step S104), which is transmitted to the bookmaker's computer with the bookmaker's user ID (step S105). The auction computer then waits for a validation response from the bookmaker's computer (step S106). If the bet is determined to be invalid, a message is generated for display to the user (step S107). If the bet is determined to be valid, bet data is retrieved from the bookmaker's computer 40 or 50 (step S108). User input auction data is input (step S109). The user auction data can comprise descriptive data, contact information, an end date and time for the auction as desired by the seller, and a starting price for the bet, which can be set at the price of the stake or at no minimum starting price for example. In step S110 auction data is generated for the auction item (bet), an auction ID is assigned and the bet data and the auction data are stored. The bet data comprises a bet ID, data identifying the outcome of the event (event name, location, date and time, event outcome, value of bet (stake), the odds, bookmaker information (ID, name, branch, reference), and auction user ID (seller ID). The auction data is generated to comprise the auction ID, the bet ID, and an end date and time. The auction data will also include bid IDs when bids are received for the auction item. The auction end date and time can be automatically generated with reference to the event date and time to ensure that the auction end time is in advance of the occurrence of the auction event. Alternatively, the system can allow the seller to enter an auction end date and time as part of the user input of the user input auction data in step S109. An auction listing record is then created (step S111) and the auction listing is placed into an auction (step S112). The bet listing process is thus complete.

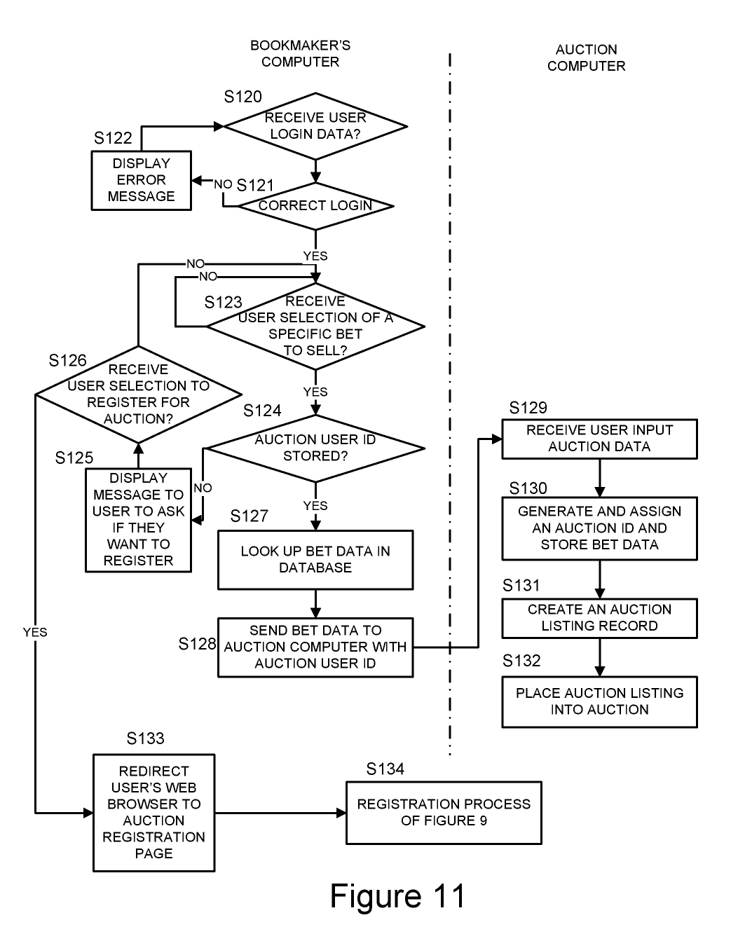

FIG. 11 is a flow diagram illustrating the process of listing a bet using the bookmaker's computer 40 or 50 according to this embodiment.

In step S120, the web server 42 or 52 serves a login web page to the web browser 71 of the seller's computer 70 and waits for the seller to login with their username and password. If the login data is incorrect (step S121) an error message is generated as a web page or part and displayed on the web browser 71 of the seller's computer 70 (step S122) and the process returns to step S120. If the login data is correct (step S121) the bookmaker's computer awaits a user selection of a specific bet to sell (step S123). Once a selection is received, it is determined whether the auction user ID is stored in the database 43 or 53 (step S124). If not, a message is generated for display to the seller to ask if the seller wishes to register for the auction service (step S125) and the process awaits a response from the seller (step S126). If the seller declines, the process loops back to step S123. If the seller accepts, the sellers web browser 71 is redirected to the auction registration web page served by the web server 61 (step S133) and the seller is then able to follow the registration process as described with reference to FIG. 9 (step S134).

If the auction user ID is determined to be stored (steps S124), the bet data for the selected bet is looked up in the database 43 or 53 (step S127) and the bet data is transmitted to the auction computer with the auction user ID (step S128). In step S129, the auction computer receives user input auction data (step S129). The user auction data can comprise descriptive data, contact information, an end date and time for the auction as desired by the seller, and a starting price for the bet, which can be set at the price of the stake or at no minimum starting price for example. In step S130 auction data is generated for the auction item (bet), an auction ID is assigned and the bet data and the auction data are stored. The bet data comprises a bet ID, data identifying the outcome of the event (event name, location, date and time, event outcome, value of bet (stake), the odds, bookmaker information (ID, name, branch, reference), and auction user ID (seller ID). The auction data is generated to comprise the auction ID, the bet ID, and an end date and time. The auction data will also include bid IDs when bids are received for the auction item. The auction end date and time can be automatically generated with reference to the event date and time to ensure that the auction end time is in advance of the occurrence of the auction event. Alternatively, the system can allow the seller to enter an auction end date and time as part of the user input of the user input auction data in step S129. An auction listing record is then created (step S131) and the auction listing is placed into an auction (step S132). The bet listing process is thus complete.

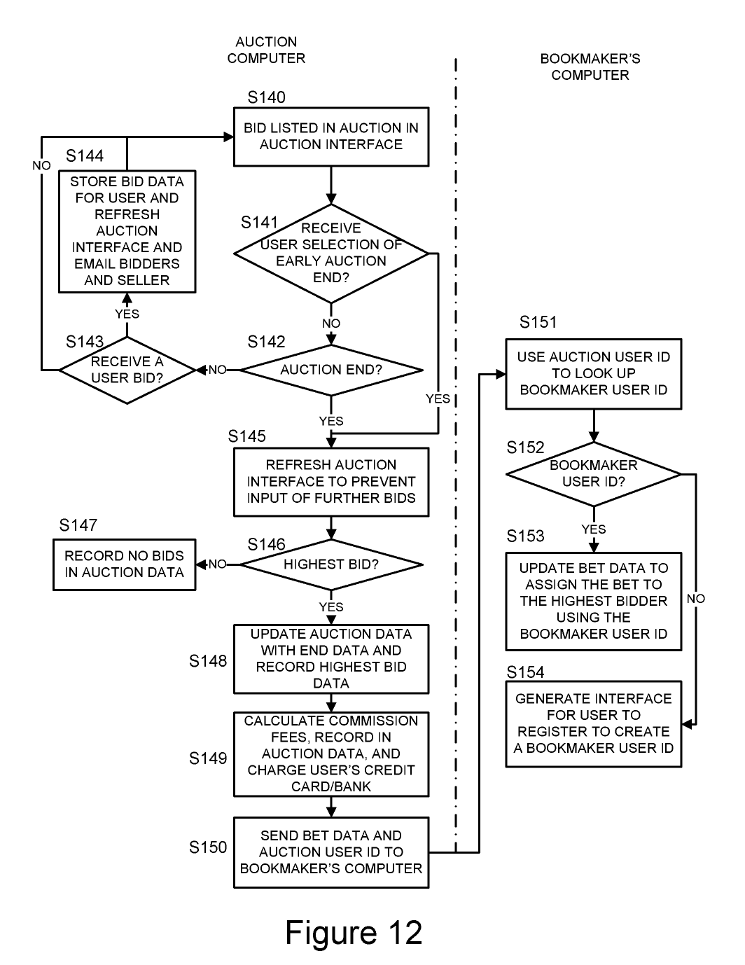

FIG. 12 is a flow diagram illustrating the process for the auctioning of a bet in accordance with this embodiment.

In step S140, the web server 61 generates a web page as an auction interface listing one or more auction items comprising bets listed by sellers. The process will be described with reference to the display of only one auction item. The item is listed in an auction until the end of the auction. In step S141, at any point in the auction in this embodiment a seller can make a selection using the interface to end the auction early. This could be to withdraw the bet from the auction or to accept the current highest bid. If the user has not selected to end the auction early in step S141. The process determines whether the date and time match the date and time set in the auction data for the end of the auction or if auction data has been received from the data source system 90 indicating the auction should be ended due to the occurrence of an event the subject of the bet (step S142). If not, the auction process waits to receive bids in step S143 and if none is received, it returns in a loop back to step S140. If a bid is input by a bidder (step S143), in step S144 bid data is stored for the bidder in the auction data and the auction interface is refreshed to show the current bid state for the auction item. In addition, the seller and all bidders for the bet are sent emails by the email server 66. Alternatively, to email, text messages could be sent if the auction user data includes the mobile number of the seller and/or bidder. The bid data comprises the auction ID, the bid value, date and time, and the auction user ID. The process then loops back to step 5140 to repeat until the auction ends at step S141 or step S142.

At the end of the auction (step S145), the auction interface provided by the web server 61 is refreshed to show the end status of the auction to bidders and the seller to prevent further bids. The process then determines if there is a highest bid i.e. any bid above the reserved minimum price set by the seller (step S146). If not a record of no bids is stored in the auction data (step S147) and the process for the auctioning of the bet is finished.

If there is a bid above the minimum set by the seller (step S146), the auction data is updated with end of auction data including a record of the highest bid and the auction end date and time (step S148). The auction record can include a record of all bids for the auction item (bet). In step S149 the commission fees for the auction service are calculated, recorded in the auction data and charged to the user's account or credit card/bank account (step S149). The bet data and the auction user ID are then sent to the bookmaker's computer (step S150). At the bookmaker's computer, the auction user ID is used to look up a bookmaker user ID (step S151). If a bookmaker user ID is found (steps S152), the bet data is updated to assign the bet to the highest bidder using the bookmaker user ID (step S153). If no bookmaker user ID is found in step S152, an interface is generated for the user to enable them to register to create an account and hence a bookmaker user ID (steps S154).

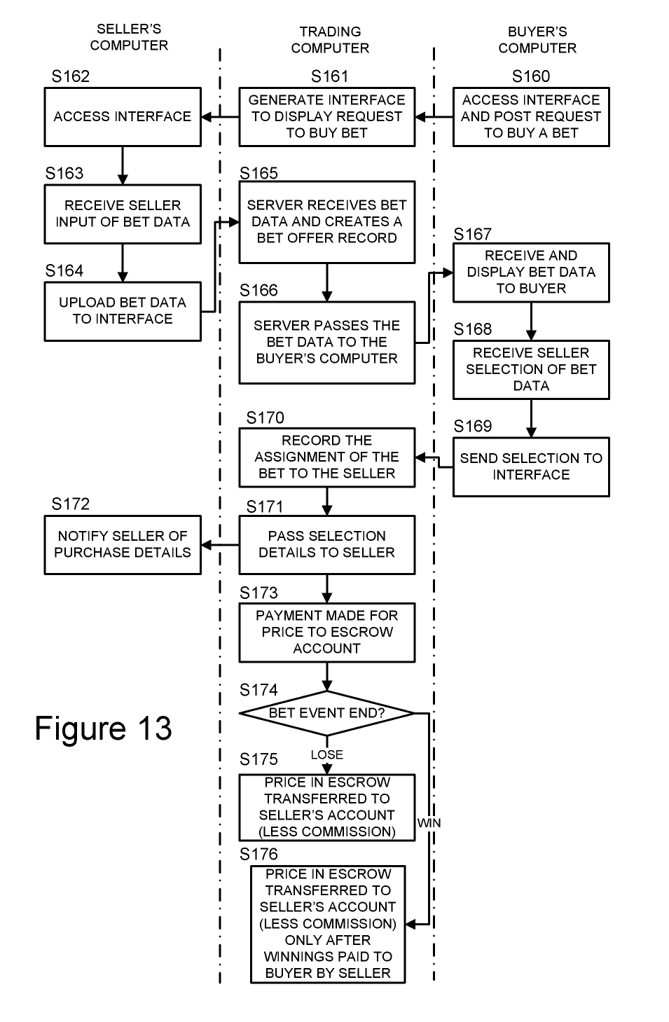

FIG. 13 is a flow diagram illustrating a bet trading process according to one embodiment. The process can be implemented using a system as described with reference to FIG. 1.

A buyer using a buyer's computer accesses an interface on a trading computer and posts a request to buy a bet (steps S160). The interface can be provided as a web page and the request can include data identifying the outcome of the event (description, date and time etc) and the desired price. It can also identify desired odds. The trading computer generates an interface to display the request to buy a bet (step S161). A seller can use a web browser to access the interface (step S162) and to input bet data for sale matching the request (step S163). A web page can provide predefined options for the entry of bet data to enable the seller to select from the options. These options are based on a database of future events and event outcomes that the system can have access to. For example, the seller can select a sport and the options will then be displayed to select an event e.g. horse racing and Cheltenham Gold Cup 12^{th} May 2014. The web page can then display the betting options including the event outcome in the form of a horse name, the type of bet e.g. win, place or each way, and the stake. The use of the options provides a simple form of validation of the bet i.e. there is an event an event outcome for the bet being entered into the auction. The seller can also be allowed to enter the data manually but the data may be flagged to indicate this. The input bet data is uploaded to the trading computer (steps S164) and the trading computer receives the bet data and created a bet offer record (step S165). The trading computer then passes the bet data to the buyer's computer (step S166), where it is received and displayed to the buyer (step S167). The buyer can then select the bet data (step S168) and the selection is sent to the trading computer (step S169), where the assignment of the bet to the seller is recorded in the bet data (step S170). The details of the selection by the buyer are then passed onto the seller (step S171) and at the seller's computer, the purchase details are displayed to notify the seller (step S172).

In step S173, the payment computer makes an electronic payment of the buy price from the account of the buyer into an escrow account. The money will stay in this account until the bet event outcome (step S174). If the bet loses, the price paid by the buyer held in the escrow account is transferred to the seller's account less commission charges by the trading system operator (step S175). If the bet wins, the price paid by the buyer held in the escrow account is transferred to the seller's account less commission charges by the trading system operator only after the winnings are paid by the seller to the buyer (step S176). This provides the buyer with some comfort that if the seller does not pay the winnings at least they can get their bid back from the escrow account.

This embodiment does not require a seller to have an account with a bookmaker and the system to interface with the bookmakers computer, in the embodiments described with reference to FIGS. 1 to 7 for example. In an alternative embodiment, similar to the embodiments described with reference to FIGS. 8 to 12, if the seller has an account with a bookmaker, there is no need to put the bid in escrow. Instead, the process for payment can be similar to steps S151 to S154 in FIG. 12, whereby the funds are transferred from a seller's account to the bidder's account at the bookmaker if the bidder has an account and if they do not, the bidder is contacted to enable them to open an account to receive the winnings.

This embodiment provides a convenient trading system in which buyers can ask for the purchase of bets. This is of use in places where bets cannot be placed or are difficult to place. The buyer can post an asking price for a bet such that a potential seller places a bet for the buyer and sells it to the buyer for a profit.

The following is a description of some generalized embodiments. Any embodiment can be used in combination with any other embodiment.

One aspect provides a computer implemented method of auctioning bets, the method comprising receiving data on a bet owned on the outcome of an event and data identifying a seller from a seller interface, the data on the bet including data on the stake and the odds; generating auction data using the received data, the auction data including an auction end time prior to the outcome of the event; generating an auction interface to display the auction data to bidders to create an auction; receiving bid data associated with the auction data and data identifying a bidder from the auction interface; terminating the auction at the auction end time and determining a bidder with a highest bid; and electronically transferring the value of the highest bid to the seller and one of: assigning the bet to the highest bidder, and if the bet wins, electronically transferring the value of the winnings from the seller to the bidder with the highest bid.

In one embodiment, the auction end time is automatically determined by reference to event data for the event.

In one embodiment, if the value of the winnings is electronically transferred from the seller to the bidder with the highest bid if the bet wins, the value of the highest bid is electronically transferred to the seller only after the value of the winnings is electronically transferred from the seller to the bidder with the highest bid.

In one embodiment, the method includes receiving data verifying the bet from a bookmaker before generating the auction data.

In one embodiment, bet verification data is included in the auction data.

In one embodiment, the auction data is generated only if the bet data is verified.

Another aspect of the invention provides a computer system for auctioning bets, the system comprising a program memory storing program code; and a processor for implementing the program code stored in the program memory; wherein the program code comprises code for controlling the processor to receive data on a bet owned on the outcome of an event and data identifying a seller from a seller interface, the data on the bet including data on the stake and the odds; code for controlling the processor to generate auction data using the received data, the auction data including an auction end time prior to the outcome of the event; code for controlling the processor to generate an auction interface to display the auction data to bidders to create an auction; code for controlling the processor to receive bid data associated with the auction data and data identifying a bidder from the auction interface; code for controlling the processor to terminate the auction at the auction end time and determining a bidder with a highest bid; and code for controlling the processor to electronically transfer the value of the highest bid to the seller and one of: assign the bet to the highest bidder, and if the bet wins, electronically transfer the value of the winnings from the seller to the bidder with the highest bid.

In one embodiment, the code for controlling the processor includes code for controlling the processor to determine the auction end time automatically by reference to event data for the event.

In one embodiment, the code for controlling the processor includes code for controlling the processor to, if the value of the winnings is electronically transferred from the seller to the bidder with the highest bid if the bet wins, transfer the value of the highest bid electronically to the seller only after the value of the winnings is electronically transferred from the seller to the bidder with the highest bid.

In one embodiment, the code for controlling the processor includes code for controlling the processor to receive data verifying the bet from a bookmaker before generating the auction data.

In one embodiment, the code for controlling the processor includes code for controlling the processor to include bet verification data in the auction data.

In one embodiment, the code for controlling the processor includes code for controlling the processor to generate the auction data only if the bet data is verified.

Another aspect of the invention provides a computer implemented method for trading bets, the method comprising passing an electronic communication from a buyer to a seller requesting to buy a bet, the request identifying an outcome of an event and the desired price; receiving an electronic response from the seller confirming the availability of the bet for sale, the electronic response identifying a stake and odds offered for a price; electronically transmitting the electronic response identifying a stake and odds offered for an offered price to the buyer; receiving confirmation from the buyer with electronic payment for the bet at the offered price; passing the confirmation to the seller; one of: assigning the bet to the buyer, and if the bet wins, electronically transferring the value of the winnings from the seller to the buyer; and electronically transferring the value of the offered price to the seller.

In one embodiment, if the value of the winnings is electronically transferred from the seller to the buyer if the bet wins, the value of the price is electronically transferred to the seller only after the value of the winnings is electronically transferred from the seller to the buyer.

In one embodiment, the method includes receiving data verifying the bet from a bookmaker before electronically transmitting the electronic response identifying a stake and odds offered for the price to the buyer.

In one embodiment, bet verification data is included in the electronic response identifying a stake and odds offered for the price transmitted to the buyer.

In one embodiment, the electronic response identifying a stake and odds offered for the price is transmitted to the buyer only if the bet data is verified.

Another aspect provides a computer system for trading bets, the system comprising a program memory storing program code; and a processor for implementing the program code stored in the program memory; wherein the program code comprises code for controlling the processor to pass an electronic communication from a buyer to a seller requesting to buy a bet, the request identifying an outcome of an event and the desired price; code for controlling the processor to receive an electronic response from the seller confirming the availability of the bet for sale, the electronic response identifying a stake and odds offered for a price; code for controlling the processor to electronically transmit the electronic response identifying a stake and odds offered for an offered price to the buyer; code for controlling the processor to receive confirmation from the buyer with electronic payment for the bet at the offered price; code for controlling the processor to pass the confirmation to the seller; code for controlling the processor to one of: assign the bet to the buyer, and if the bet wins, electronically transfer the value of the winnings from the seller to the buyer; and code for controlling the processor to electronically transfer the value of the offered price to the seller.

In one embodiment, the code for controlling the processor includes code for controlling the processor to, if the value of the winnings is electronically transferred from the seller to the buyer if the bet wins, transfer the value of the price electronically to the seller only after the value of the winnings is electronically transferred from the seller to the buyer.

In one embodiment, the code for controlling the processor includes code for controlling the processor to receive data verifying the bet from a bookmaker before electronically transmitting the electronic response identifying a stake and odds offered for the price to the buyer.

In one embodiment, the code for controlling the processor includes code for controlling the processor to include bet verification data in the electronic response identifying a stake and odds offered for the price transmitted to the buyer.

In one embodiment, the code for controlling the processor includes code for controlling the processor to transmit the electronic response identifying a stake and odds offered for the price to the buyer only if the bet data is verified.

Another aspect provides a computer implemented method for the auctioning of bets, the method comprising receiving data on a bet owned on an event outcome and data identifying a seller from a seller interface, the data on the bet including data on a stake and the odds; generating and outputting auction data using the received data, the auction data including data identifying the outcome of the event, the stake bet on the outcome of the event, a highest received bid, original odds for the outcome of the event at which the bet was placed, and odds currently being offered by third parties for the outcome of the event to enable a potential bidder to compare the original odds to the odds currently being offered by third parties; and receiving bid data for the bets from bidders, the bid data including the highest received offer.

In one embodiment, equivalent odds are determined based on the stake, the original odds, and the highest received bid, and the equivalent odds are included in the auction data to enable the potential bidder to compare the odds currently being offered by third parties with the equivalent odds.

Another aspect provides a computer system for the auctioning of bets, the system comprising a program memory storing program code; and a processor for implementing the program code stored in the program memory; wherein the program code comprises: code for controlling the processor to receive data on a bet owned on an outcome of an event and data identifying a seller from a seller interface, the data on the bet including data on a stake and the odds; code for controlling the processor to generate and output auction data using the received data, the auction data including data identifying the outcome of the event, the stake bet on the outcome of the event, a highest received bid, original odds for the outcome of the event at which the bet was placed, and odds currently being offered by third parties for the outcome of the event to enable a potential bidder to compare the original odds to the odds currently being offered by third parties; and code for controlling the processor to receive bid data for the bets from bidders, the bid data including the highest received offer.

In one embodiment, the code for controlling the processor includes code for controlling the processor to determine equivalent odds based on the stake, the original odds, and the highest received bid, and code for controlling the processor to include the equivalent odds in the auction data to enable the potential bidder to compare the odds currently being offered by third parties with the equivalent odds.

Another aspect provides a computer implemented method of auctioning bets, the method comprising receiving data on a bet owned on the outcome of an event and data identifying a seller from a bookmaker's computer, the data on the bet including data on the bet owner, the outcome of the event, the stake, the odds, and the bookmaker; generating auction data using the received data, the auction data including an auction end time prior to the outcome of the event; generating an auction interface to display the auction data to bidders to create an auction; receiving bid data associated with the auction data and data identifying a bidder from the auction interface; terminating the auction at the auction end time and determining a bidder with a highest bid; electronically transferring the value of the winnings from the seller to the bidder with the highest bid; electronically transferring the value of the highest bid to the seller; and transmitting data identifying the bet and bid data for the highest bidder to the bookmaker's computer for the transfer of the bet to the highest bidder.

In one embodiment, the auction end time is automatically determined by reference to event data for the event.

Another aspect provides a computer system for auctioning bets, the system comprising a program memory storing program code; and a processor for implementing the program code stored in the program memory; wherein the program code comprises code for controlling the processor to receive data on a bet owned on the outcome of an event and data identifying a seller from a bookmaker's computer, the data on the bet including data on the bet owner, the outcome of the event, the stake, the odds, and the bookmaker; code for controlling the processor to generate auction data using the received data, the auction data including an auction end time prior to the outcome of the event; code for controlling the processor to generate an auction interface to display the auction data to bidders to create an auction; code for controlling the processor to receive bid data associated with the auction data and data identifying a bidder from the auction interface; code for controlling the processor to terminate the auction at the auction end time and determine a bidder with a highest bid; code for controlling the processor to electronically transfer the value of the winnings from the seller to the bidder with the highest bid; code for controlling the processor to electronically transfer the value of the highest bid to the seller; and code for controlling the processor to transmit data identifying the bet and bid data for the highest bidder to the bookmaker's computer for the transfer of the bet to the highest bidder.

In one embodiment, the code for controlling the processor includes code for controlling the processor to determine the auction end time automatically by reference to event data for the event.

Another aspect provides a carrier medium such as a non-transient storage medium storing computer code for controlling a computer to carry out the method, or a transient medium carrying computer readable code for controlling a computer to carry out the method. Embodiments can be implemented in programmable digital logic that implements computer code. The code can be supplied to the programmable logic, such as a processor or microprocessor, on a carrier medium. One such form of carrier medium is a transient medium i.e. a signal such as an electrical, electromagnetic, acoustic, magnetic, or optical signal. Another form of carrier medium is a non-transitory medium that carries or stores the code, such as a solid-state memory, magnetic media (hard disk drive), or optical media (Compact disc (CD) or digital versatile disc (DVD)).

Although in the embodiments are described with reference to seller's computers and buyer's computers, the invention covers the use of any computing devices by a seller and a bidder. For example, the computer used by bidders and sellers can be the same computer that could for example be provided in a locations or as a terminal in a bookmakers premises (betting shop). The sellers and buyers can use computing devices that can comprise any device capable of connecting over a network to the service, such as mobile devices e.g. smart phones, tablet computers, laptop computers, which can connect over a wireless network such as Wi-Fi, Bluetooth or a wireless cellular network.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1.-32. (canceled)

33. A computer implemented method of auctioning bets, the method comprising:
receiving data on a bet owned on an outcome of an event and data identifying a seller from a seller interface over a communications network, the data on the bet including data on the stake and the odds;
generating, using a processor, auction data using the received data, the auction data including an auction end time prior to an outcome of the event;
generating an auction interface to display the auction data to bidders to create an auction over the communications network;
receiving, over the communications network, bid data associated with the auction data and data identifying a bidder from the auction interface;
terminating the auction at the auction end time and processing the auction data to determine a bidder with a highest bid; and
electronically transferring, over the communications network, the data for the value of the highest bid to the seller and one of: assigning the bet to the highest bidder, and if the bet is successful, electronically transferring, over the communications network, the data for the value of the winnings from the seller to the bidder with the highest bid.

34. A method according to claim 33, wherein the auction end time is automatically determined by reference to event data from an event data source received over the communications network for the event.

35. A method according to claim 34, wherein the event data is received for the event in real time or near real time.

36. A method according to claim 33, wherein if the value of the winnings is electronically transferred from the seller to the bidder with the highest bid if the bet wins, the value of the highest bid is electronically transferred to the seller only after the value of the winnings is electronically transferred from the seller to the bidder with the highest bid.

37. A method according to claim 33, including receiving data verifying the bet from a bookmaker before generating the auction data.

38. A method according to claim 37, wherein bet verification data is included in the auction data.

39. A method according to claim 37, wherein the auction data is generated only if the bet data is verified.

40. A computer system for auctioning bets, the system comprising:
a program memory storing program code; and
a processor for implementing the program code stored in the program memory;
wherein the program code comprises:
code for controlling the processor to receive data on a bet owned on the outcome of an event and data identifying a seller from a seller interface over a communications network, the data on the bet including data on the stake and the odds;
code for controlling the processor to generate auction data using the received data, the auction data including an auction end time prior to an outcome of the event;
code for controlling the processor to generate an auction interface over the communications network, to display the auction data to bidders to create an auction;
code for controlling the processor to receive bid data associated with the auction data over the communications network, and data identifying a bidder from the auction interface;
code for controlling the processor to terminate the auction at the auction end time and determining a bidder with a highest bid; and
code for controlling the processor to electronically transfer data for the value of the highest bid to the seller and one of: assign the bet to the highest bidder, and if the bet wins, electronically transfer over the communications network, the data for the value of the winnings from the seller to the bidder with the highest bid.

41. A computer system according to claim 40, wherein the code for controlling the processor includes code for controlling the processor to determine the auction end time automatically by reference to event data from an event data source received over the communications network for the event.

42. A computer system according to claim 41, wherein the code for controlling the processor includes code for controlling the processor to receive the event data for the event in real time or near real time.

43. A computer system according to claim 42, wherein the code for controlling the processor includes code for controlling the processor to, if the value of the winnings is electronically transferred from the seller to the bidder with the highest bid if the bet wins, transfer the value of the highest bid electronically to the seller only after the value of the winnings is electronically transferred from the seller to the bidder with the highest bid.

44. A computer system according to claim 42, wherein the code for controlling the processor includes code for controlling the processor to receive data verifying the bet from a bookmaker before generating the auction data.

45. A computer system according to claim 44, wherein the code for controlling the processor includes code for controlling the processor to include bet verification data in the auction data.

46. A computer system according to claim 44, wherein the code for controlling the processor includes code for controlling the processor to generate the auction data only if the bet data is verified.

47. A computer implemented method for trading bets, the method comprising:
transmitting an electronic communication over a communications network from a buyer to a seller requesting to buy a bet, the request identifying an event outcome and the desired price;
receiving an electronic response from the seller over the communications network confirming the availability of the bet for sale, the electronic response identifying a stake and odds offered for a price;
electronically transmitting over the communications network, the electronic response identifying a stake and odds offered for an offered price to the buyer;
receiving over the electronic communications network confirmation from the buyer with electronic payment for the bet at the offered price;
transmitting the confirmation to the seller over the communications network;
one of: processing the bet using a processor to assign the bet to the buyer, and if the bet wins, electronically transferring the value of the winnings from the seller to the buyer over the communications network; and
electronically transferring the value of the offered price to the seller over the communications network.

48. A method according to claim 47, wherein if the value of the winnings is electronically transferred from the seller to the buyer if the bet wins, the value of the price is electronically transferred to the seller only after the value of the winnings is electronically transferred from the seller to the buyer.

49. A method according to claim 47, including receiving data verifying the bet over the communications network from a bookmaker before electronically transmitting the electronic response identifying a stake and odds offered for the price to the buyer over the communications network.

50. A method according to claim 49, wherein bet verification data is included in the electronic response identifying a stake and odds offered for the price transmitted to the buyer.

51. A method according to claim 49, wherein the electronic response identifying a stake and odds offered for the price is transmitted to the buyer only if the bet data is verified.

52. A computer system for trading bets, the system comprising:
a program memory storing program code; and
a processor for implementing the program code stored in the program memory;
wherein the program code comprises:
code for controlling the processor to transmit an electronic communication over a communications network from a buyer to a seller requesting to buy a bet, the request identifying an event outcome and the desired price;
code for controlling the processor to receive over the communications network, an electronic response from the seller confirming the availability of the bet for sale, the electronic response identifying a stake and odds offered for a price;
code for controlling the processor to electronically transmit the electronic response identifying a stake and odds offered for an offered price to the buyer over the communications network;
code for controlling the processor to receive confirmation from the buyer with electronic payment for the bet at the offered price over the communications network;
code for controlling the processor to transmit the confirmation to the seller over the communications network;
code for controlling the processor to one of: process the bet data to assign the bet to the buyer, and if the bet wins, electronically transfer the value of the winnings from the seller to the buyer over the communications network; and
code for controlling the processor to electronically transfer the value of the offered price to the seller over the communications network.

53. A computer system according to claim 52, wherein the code for controlling the processor includes code for controlling the processor to, if the value of the winnings is electronically transferred from the seller to the buyer over the communications network if the bet wins, transfer the value of the price electronically to the seller over the communications network only after the value of the winnings is electronically transferred from the seller to the buyer over the communications network.

54. A computer system according to claim 52, wherein the code for controlling the processor includes code for controlling the processor to receive data verifying the bet from a bookmaker over the communications network before electronically transmitting the electronic response identifying a stake and odds offered for the price to the buyer over the communications network.

55. A computer system according to claim 54, wherein the code for controlling the processor includes code for controlling the processor to include bet verification data in the electronic response identifying a stake and odds offered for the price transmitted to the buyer.

56. A computer system according to claim 54, wherein the code for controlling the processor includes code for controlling the processor to transmit the electronic response identifying a stake and odds offered for the price to the buyer over the communications network only if the bet data is verified.

57. A computer implemented method for the auctioning of bets, the method comprising:
receiving data on a bet owned on an outcome of an event and data identifying a seller from a seller interface over a communications network, the data on the bet including data on a stake and the odds;
generating and outputting auction data using the received data over the communications network, the auction data including data identifying the outcome of the event, the stake bet on the outcome of the event, a highest received bid, original odds for the outcome of the event at which the bet was placed, and odds currently being offered by third parties for the outcome of the event to enable a potential bidder to compare the original odds to the odds currently being offered by third parties; and
receiving bid data for the bets from bidders over the communications network, the bid data including the highest received offer.

58. A method according to claim 57, wherein equivalent odds are determined based on the stake, the original odds, and the highest received bid, and the equivalent odds are included in the auction data to enable the potential bidder to compare the odds currently being offered by third parties with the equivalent odds.

59. A computer system for the auctioning of bets, the system comprising:
a program memory storing program code; and
a processor for implementing the program code stored in the program memory;
wherein the program code comprises:
code for controlling the processor to receive data on a bet owned on an outcome of an event and data identifying a seller from a seller interface over a communications interface, the data on the bet including data on a stake and the odds;
code for controlling the processor to generate and output auction data using the received data over the communications network, the auction data including data identifying the outcome of the event, the stake bet on the outcome of the event, a highest received bid, original odds for the outcome of the event at which the bet was placed, and odds currently being offered by third parties for the outcome of the event to enable a potential bidder to compare the original odds to the odds currently being offered by third parties; and
code for controlling the processor to receive bid data for the bets from bidders over the communications network, the bid data including the highest received offer.

60. A computer system according to claim 59, wherein the code for controlling the processor includes code for controlling the processor to determine equivalent odds based on the stake, the original odds, and the highest received bid, and code for controlling the processor to include the equivalent odds in the auction data to enable the potential bidder to compare the odds currently being offered by third parties with the equivalent odds.

61. A computer implemented method of auctioning bets, the method comprising:
receiving, over a communications network, data on a bet owned on the outcome of an event and data identifying a seller from a bookmaker's computer, the data on the bet including data on the bet owner, the outcome of the event, the stake, the odds, and the bookmaker;
generating, using a processor, auction data using the received data, the auction data including an auction end time prior to an outcome of the event;
generating an auction interface output over the communications interface to display the auction data to bidders to create an auction;
receiving bid data associated with the auction data and data identifying a bidder from the auction interface over the communications network;
processing the bid data using the processor to terminate the auction at the auction end time and determining a bidder with a highest bid;
electronically transferring the value of the winnings from the seller to the bidder with the highest bid;
electronically transferring the value of the highest bid to the seller; and
transmitting data identifying the bet and bid data for the highest bidder to the bookmaker's computer for the transfer of the bet to the highest bidder.

62. A method according to claim 61, wherein the auction end time is automatically determined by reference to event data from an event data source received over the communications network for the event.

63. A method according to claim 62, wherein the event data is received for the event in real time or near real time.

64. A computer system for auctioning bets, the system comprising:
a program memory storing program code; and
a processor for implementing the program code stored in the program memory;
wherein the program code comprises:
code for controlling the processor to receive data on a bet owned on the outcome of an event and data identifying a seller from a bookmaker's computer over a communications network, the data on the bet including data on the bet owner, the outcome of the event, the stake, the odds, and the bookmaker;
code for controlling the processor to generate auction data using the received data, the auction data including an auction end time prior to an outcome of the event;
code for controlling the processor to generate an auction interface to display the auction data to bidders to create an auction over the communications network;
code for controlling the processor to receive bid data associated with the auction data and data identifying a bidder from the auction interface over the communications network;
code for controlling the processor to terminate the auction at the auction end time and determine a bidder with a highest bid;
code for controlling the processor to electronically transfer the value of the winnings from the seller to the bidder with the highest bid over the communications network;
code for controlling the processor to electronically transfer the value of the highest bid to the seller over the communications network; and
code for controlling the processor to transmit data identifying the bet and bid data for the highest bidder to the bookmaker's computer over the communications network for the transfer of the bet to the highest bidder.

65. A computer system according to claim 64, wherein the code for controlling the processor includes code for controlling the processor to determine the auction end time automatically by reference to event data from an event data source received over the communications network for the event.

66. A computer system according to claim 65, wherein the event data is received for the event in real time or near real time.
